(19) United States
(12) Patent Application Publication
(10) Pub. No.: US 2021/0318553 A1
(43) Pub. Date: Oct. 14, 2021

(54) CAP SHIELD OR CAP LENS

(71) Applicant: Armen Gharabegian, Glendale, CA (US)

(72) Inventor: Armen Gharabegian, Glendale, CA (US)

(21) Appl. No.: 17/225,950

(22) Filed: Apr. 8, 2021

Related U.S. Application Data
(60) Provisional application No. 63/022,094, filed on May 8, 2020.
(60) Provisional application No. 63/012,140, filed on Apr. 18, 2020.
(60) Provisional application No. 63/007,366, filed on Apr. 9, 2020.

(51) Int. Cl. G02C 3/02; G02C 7/10

(52) U.S. Cl. CPC G02C 3/02; G02C 2200/02; G02C 7/10

(57) ABSTRACT

A cap shield includes two or more side attachment assemblies; the two or more side attachment assemblies including corresponding two or more top portions and two or more clip assemblies, the two or more clip assemblies directed downward in a vertical direction which is perpendicular to the top portion, the two or more side attached assemblies to attach to a bill of a cap. The cap shield further includes a shield attachment assembly, the shield attachment assembly include two or more side portions having associated two or more recesses to receive the two or more clip assemblies to connect the two or more side attachment assemblies to the shield attachment assembly; and a shield or lens, the shield or lens to be attached to the shield attachment assembly.

### RELATED APPLICATIONS

This application claims priority and is related to U.S. provisional patent application Ser. No. 63/007,366, filed Apr. 9, 2020, entitled “Cap Shield”; U.S. provisional patent application Ser. No. 63/012,140, filed Apr. 18, 2020, entitled “Cap Shield Configurations”; and U.S. provisional patent application Ser. No. 63/022,094, filed May 8, 2020, entitled “Cap Lens or Cap Shade,” the disclosures of which are hereby incorporated by reference.

### BRIEF DESCRIPTION OF DRAWINGS

FIG. 1A illustrates a top view of a configuration of a cap shield according to some embodiments;

FIG. 1B illustrates a front view of a configuration of a cap shield according to some embodiments;

FIG. 1C illustrates a right-side perspective view of a configuration of a cap shield according to some embodiments;

FIG. 1D illustrates a left-side perspective view of a configuration of a cap shield according to some embodiments;

FIG. 2A illustrates a top view of a second configuration of a cap shield according to some embodiments;

FIG. 2B illustrates a front view of a second configuration of a cap shield according to some embodiments;

FIG. 2C illustrates a right-side perspective view of a second configuration of a cap shield according to some embodiments;

FIG. 2D illustrates a left-side perspective view of a second configuration of a cap shield according to some embodiments;

FIG. 3A illustrates a top view of a third configuration of a cap shield according to some embodiments;

FIG. 3B illustrates a front view of a third configuration of a cap shield according to some embodiments;

FIG. 3C illustrates a right-side perspective view of a third configuration of a cap shield according to some embodiments;

FIG. 3D illustrates a left-side perspective view of a third configuration of a cap shield according to some embodiments;

FIG. 4A illustrates a top view of a fourth configuration of a cap shield according to some embodiments;

FIG. 4B illustrates a front view of a fourth configuration of a cap shield according to some embodiments;

FIG. 4C illustrates a right-side perspective view of a fourth configuration of a cap shield according to some embodiments;

FIG. 4D illustrates a left-side perspective view of a fourth configuration of a cap shield according to some embodiments;

FIG. 5A illustrates a top view of a fifth configuration of a cap shield according to some embodiments;

FIG. 5B illustrates a front view of a fifth configuration of a cap shield according to some embodiments;

FIG. 5C illustrates a right-side perspective view of a fifth configuration of a cap shield according to some embodiments;

FIG. 5D illustrates a left-side perspective view of a fifth configuration of a cap shield according to some embodiments;

FIG. 6A illustrates a top view of a sixth configuration of a cap shield according to some embodiments;

FIG. 6B illustrates a front view of a sixth configuration of a cap shield according to some embodiments;

FIG. 6C illustrates a right-side perspective view of a sixth configuration of a cap shield according to some embodiments;

FIG. 6D illustrates a left-side perspective view of a sixth configuration of a cap shield according to some embodiments;

FIG. 7 illustrates different views of a cap face shield that may be placed onto a cap according to some embodiments.

FIG. 8 illustrates the piece of the cap face shield that is placed over the bill of the cap in order to assist in holding the cap face shield on the cap according to some embodiments.

FIG. 9 illustrates a side view and a front view of the cap insertion piece or section that of the cap face shield according to some embodiments.

FIG. 10 is a rendering of a cap shield according to some embodiments;

FIG. 11A is a top view of a cap shield according to some embodiments;

FIG. 11B is a front view of a cap shield according to some embodiments;

FIG. 11C is a right perspective view of a cap shield according to some embodiments;

FIG. 11D is a left side view of a cap shield according to some embodiments;

FIG. 12A illustrates a top view of a cap shield according to some embodiments;

FIG. 12B illustrates a front view of a cap shield according to some embodiments;

FIG. 12C illustrates a right perspective view of a cap shield according to some embodiments;

FIG. 12D illustrates a left perspective view of a cap shield according to some embodiments

FIG. 13A illustrates a top view of a cap visor shield according to some embodiments;

FIG. 13B illustrates a front view of a cap visor shield according to some embodiments;

FIG. 13C illustrates a right side perspective view of a cap visor shield according to some embodiments; and

FIG. 13D illustrates a left side perspective view of a cap visor shield according to some embodiments;

FIG. 14A illustrates a top view of a second configuration of a cap visor shield according to some embodiments;

FIG. 14B illustrates a front view of a cap visor shield according to some embodiments;

FIG. 14C illustrates a right side perspective view of a cap visor shield according to some embodiments;

FIG. 14D illustrates a left side perspective view of a cap visor shield according to some embodiments;

FIG. 15A illustrates a top view of a cap shield according to some embodiments;

FIG. 15B illustrates a left perspective view of a cap shield according to some embodiments;

FIG. 15C illustrates a back right perspective view of a cap shield according to some embodiments;

FIG. 15D illustrates a front right perspective view of a cap shield according to some embodiments; and

FIG. 15E illustrates a back view of a cap shield according to some embodiments.

### DETAILED DESCRIPTION

The present invention is directed to an extendable and retractable insulated beverage holder. The following detailed description and provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

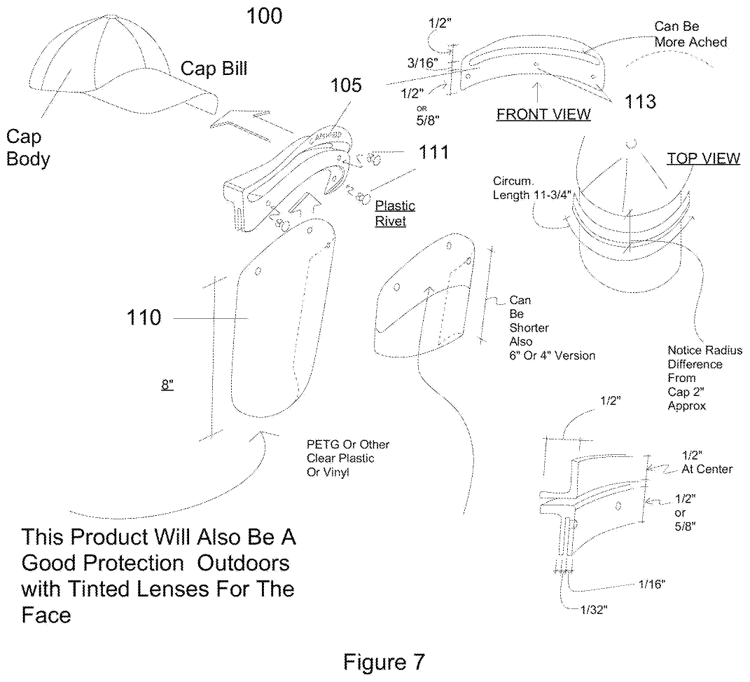

FIG. 7 illustrates different views of a cap face shield that may be placed onto a cap according to some embodiments. The cap face shield 100 may comprise a connection plate 105 and a face shield 110. The face shield may be connected to the connection plate via one or more connectors 111. FIG. 7 shows that the connection may be made utilizing 3 plastic rivets which, pass through openings 113 in the front side of the connection plate 105, pass through openings in the face shield 110 (at a top portion of the face shield) and then fasten or connect to an interior surface of the face shield. In some embodiments, the connection plate 105 may have an opening 106. In some embodiments, the opening 106 may run from one side of the connection plate 105 to the second side (e.g., from the left side to the right side). In some embodiments, the opening 106 may not run the whole width of the connection plate 105. In some embodiments, the left and right ends of the opening 106 may press against a bill of the cap and provide a good fit of the cap face shield against the cap. In other words, once the connection plate 105 is placed on bill of the cap friction may prevent the bill from moving from the connection plate 105. In some embodiments, the width and height of the opening 106 may be slightly larger than the width and height of the bill of the cap. In some embodiments, the opening 106 may be arched or curved in order for the bill of the cap to fit through the opening. In some embodiments, the opening 106 may have a height of 3/16″ or be in a range from ¼″ to ½″. In some embodiments, the connection plate may have a total height that may range from 1 3/16 inches up until 2½ inches and may vary depending on the size of the bill of the cap. The height and width of the opening 106 may vary depending on the dimensions of the bill of the cap. In some embodiments, the connection plate 106 may be made of a plastic material, a composite material, a material that is made by additive manufacturing techniques (e.g., 3D printing), a wood material, or a combination thereof.

In some embodiments, the face shield 110 may be made of PETG or other clear plastic or vinyl material. The face shield may also be made of a tinted material in order to protect a user from the sun. Thus, it may have a dual purpose of protecting you from the sun and also from bacterial or viral particles of others. In addition, the face shield 110 may keep you from spreading germs by catching particles or materials projected when you sneeze or cough. In some embodiments, the face shield may also protect first responders and/or health care workers from viral and/or bacterial diseases by providing a barrier between the personnel and the patients.

In some embodiments, the face shield 110 may be 2 inches, 4 inches or 6 inches in height. In some embodiments, face shield 110 may have a width approximately the same size as a circumference of the bill of a cap (so it fits around the curves of the cap). In some embodiments, the face shield 110 may have a width smaller than the circumference of the bill of the cap. In some embodiments, the face shield 110 may have a width slightly larger than the bill of the cap.

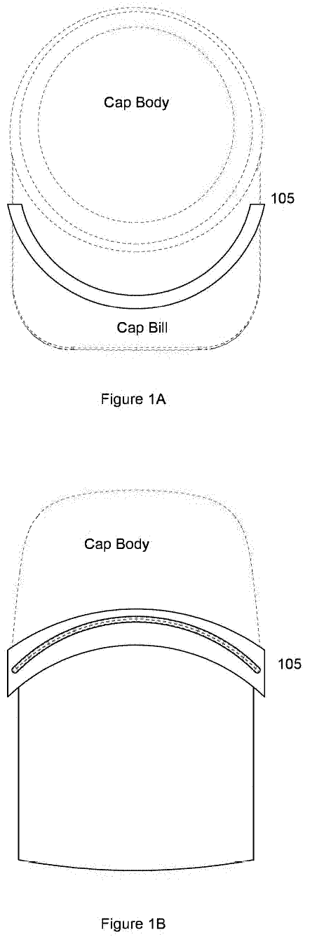

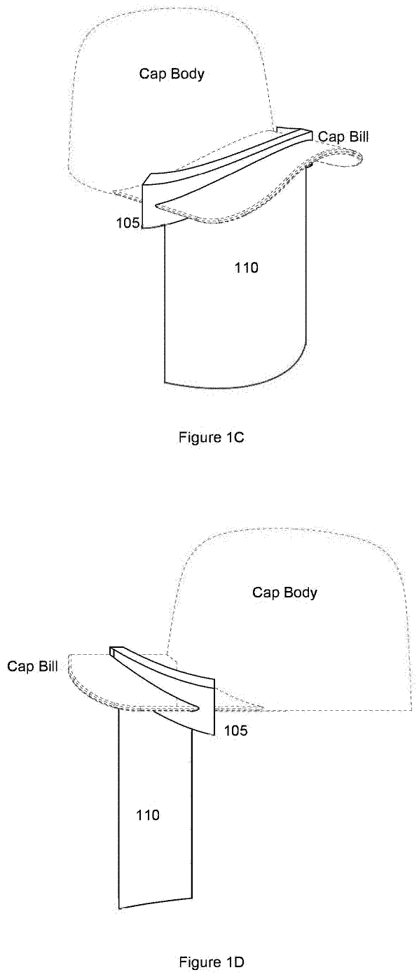

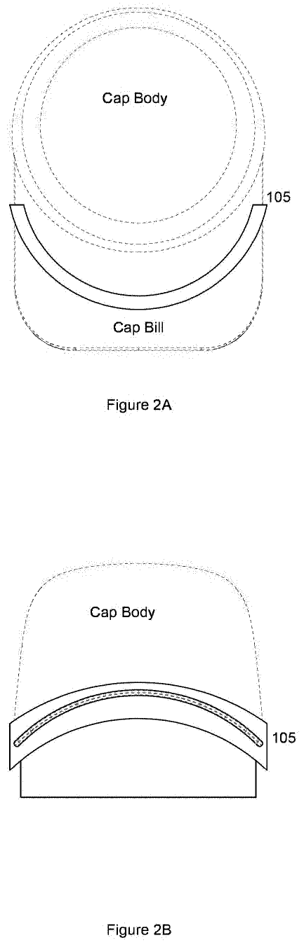

In some embodiments, the connection plate 105 may have a channel 107 on its bottom side where the face shield 110 can be inserted into in order to be attached and/or connected to the connection plate 105. In some embodiments, the width of this channel 107 may be 1/16^{th} of an inch or 1/32^{nd} of an inch. In some embodiments, the connection plate 105 may be placed over the bill of the cap and be pushed back so it rests against the main portion or body of the cap. Thus, a back surface of the of the connection plate 105 may also be curved in order to fit around the body portion of the cap as shown in the top view of FIG. 1.

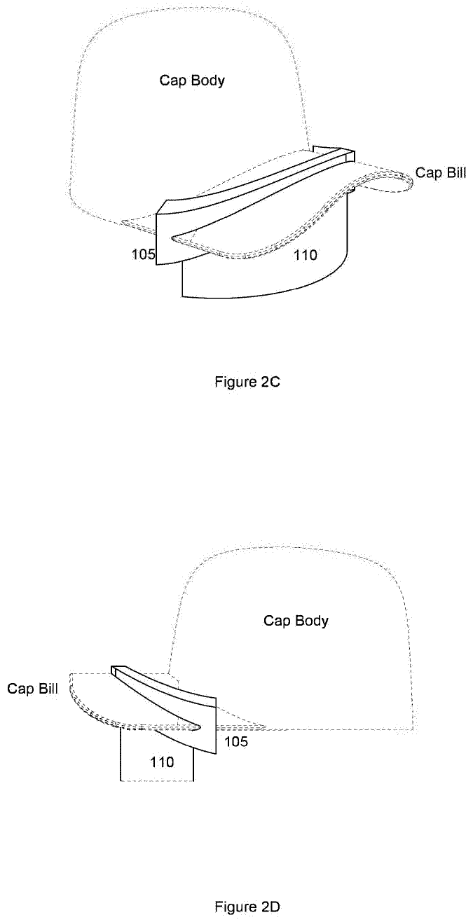

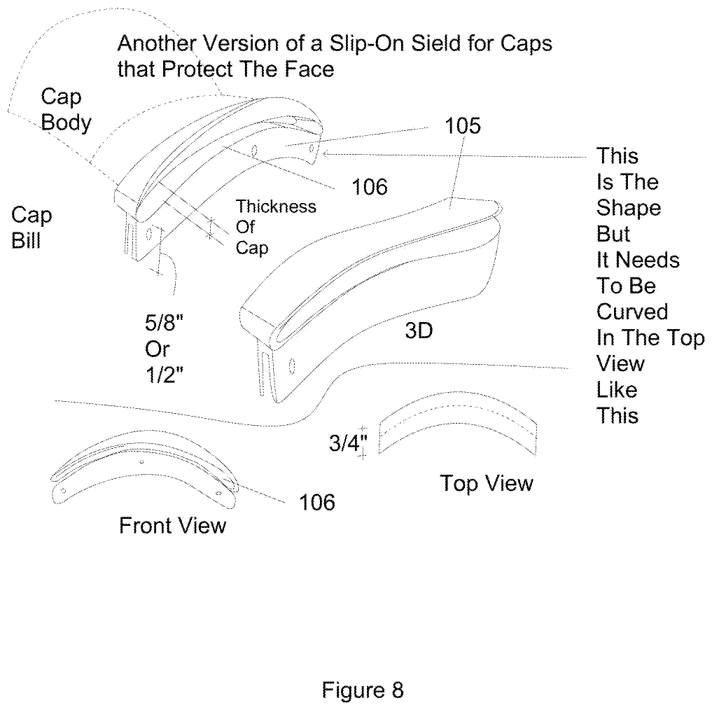

FIGS. 2A-2D is another view of the connection plate according to some embodiments. In some embodiments, this cap face shield version includes a slip-on cap face shield that protects a user's face. FIG. 8 shows a potential shape of the connection plate 105 and it may be curved in a top view in order to fit against the main portion of the cap. In some embodiments, it is almost a semi-circular shape in order to fit the shape of the main portion of the cap. FIG. 8 includes top perspective views, front views and/or a top view of the connection plate of the connection plate according to some embodiments.

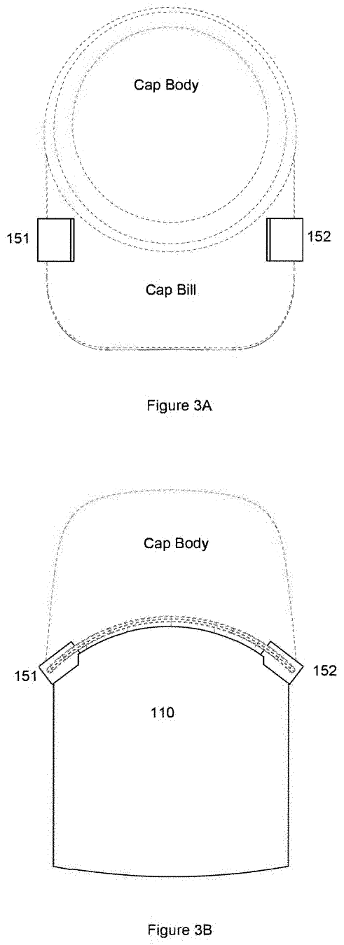

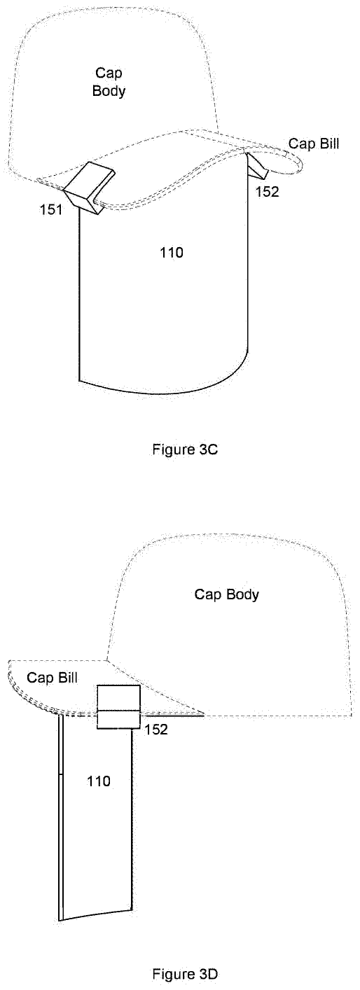

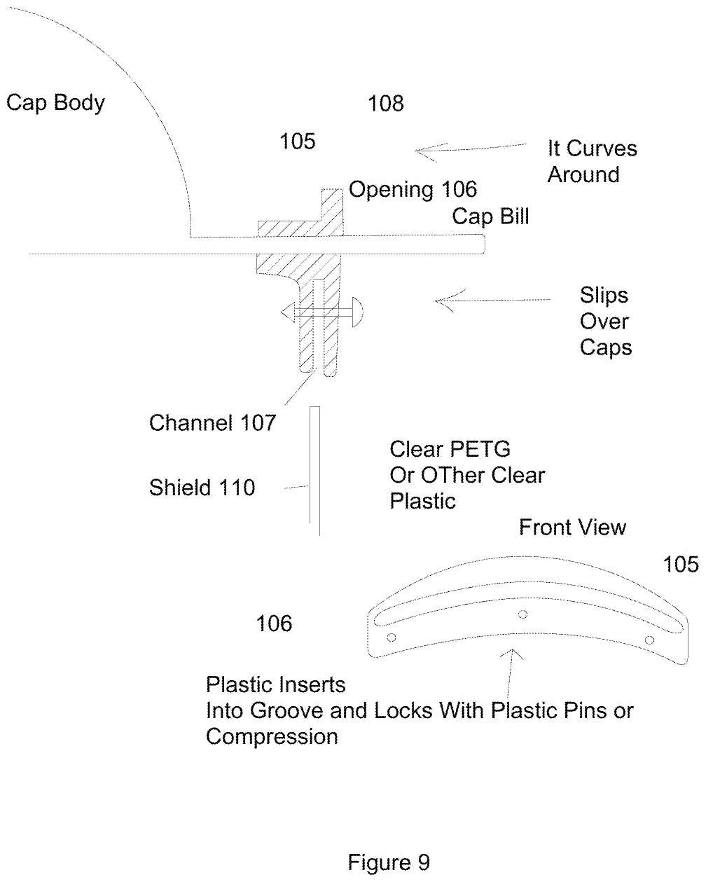

FIG. 9 shows how the connection plate is connected to the bill of the cap as well as the face shield. In some embodiments, a top portion 108 of the connection plate 105 may curve around to allow the connection plate 105 to fit next to the main or body portion of the cap. FIG. 9 also shows how the bill 112 of the cap fits through the opening 106 of the connection plate 105. In some embodiments, the opening 105 is a horizontal opening. FIG. 3 also shows the vertical channel 107 on the bottom side of the connection plate 105 according to some embodiments. In some embodiments, the clear or tinted plastic, PETG or acrylic face shield is inserted into the vertical channel 107 of the connection plate 105. FIG. 3 also shows a front view of the connection plate and shows the holes or openings 113 that are in the front side of the connection plate 105 that allows pins, locks, or compression springs or plastic inserts to be placed into the openings 113 and then through openings 113 in the face shield 110 to connect to the connection plate 105 on the other side of the channel 107 to make sure that the face shield does not move once inserted into the vertical.

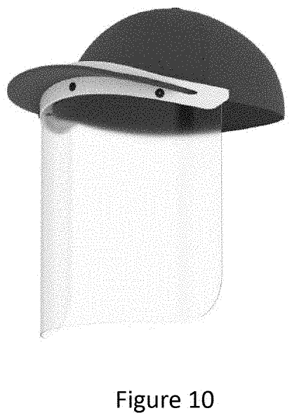

Please note that the cap face shield may also be utilized with visors and thus is not limited to a ball cap. In some embodiments, the connection plate 105 may connect to the cap utilizing form and/or friction. In some embodiments, the primary protection to the user is not only the front of the face shield but also the edges of the face shield. In addition, the slip on aspect of connection plate is quite different than other versions. In addition, the interchangeable lenses are also a distinctive fashion of this. Further, the fact that the shield can be tinted provides sun protection as well as protection against bacteria and other particles. In some embodiments, the shield may be made of an ultraviolet (UV) material. In short, the cap face shield relies on the cap (e.g., the cap bill) for support. FIG. 10 illustrates a rendering of the cap shield device.

FIGS. 1A-1D illustrate one configuration of a cap face shield according to some embodiments. This is the configuration discussed above with respect to FIGS. 7-10.

FIGS. 2A-2D illustrate a second configuration of a cap face shield according to some embodiments. In this embodiment, the face shield 110 has a smaller length. However, it is curved and provides protection from the sun.

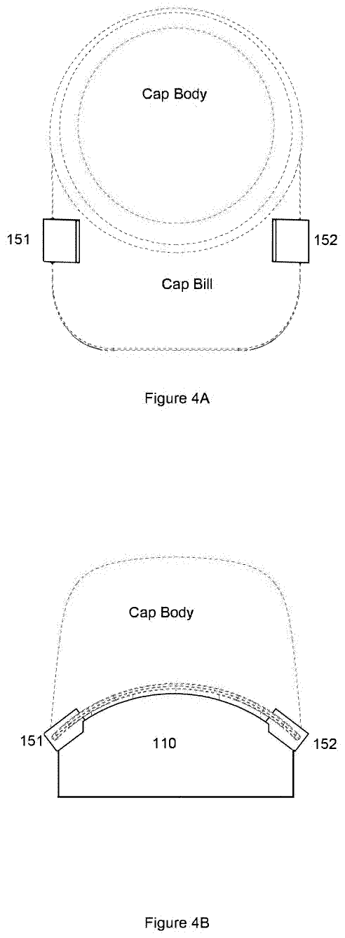

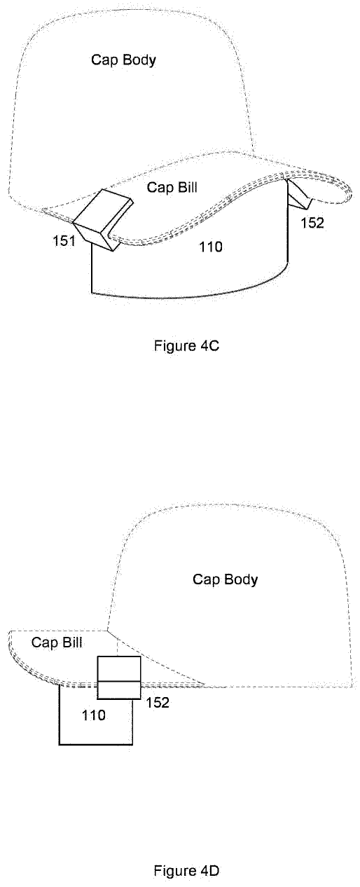

FIGS. 3A-3D illustrates a third configuration of a cap face shield according to some embodiments. In this embodiments, clips 151 and 152 on the side of the cap hole the face shield in place. Specifically, the clips 151 and 152 are on the sides of the cap bill. In addition, the clips 151 and 152 have channels on the bottom side into which the shield 110 may be inserted. In some embodiments, the clips 151 and 152 have an opening that clasps around the bill of the cap. In some embodiments, the clips 151 and 152 are U-shaped where the inside of the U is what is clasped around the cap. In some embodiments, the clips 151 and 152 may be made of a malleable material that can be pressed against cap bill. FIGS. 4A-4D illustrates a fourth configuration of a cap face shield according to some embodiments where the shield 110 has a smaller length and the clips 151 and 152 are utilized.

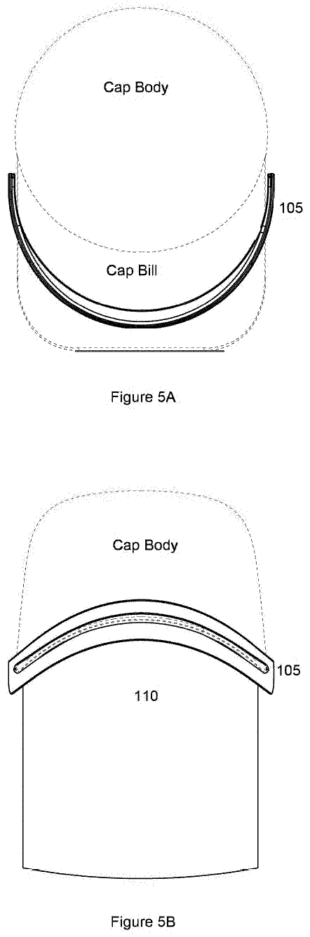

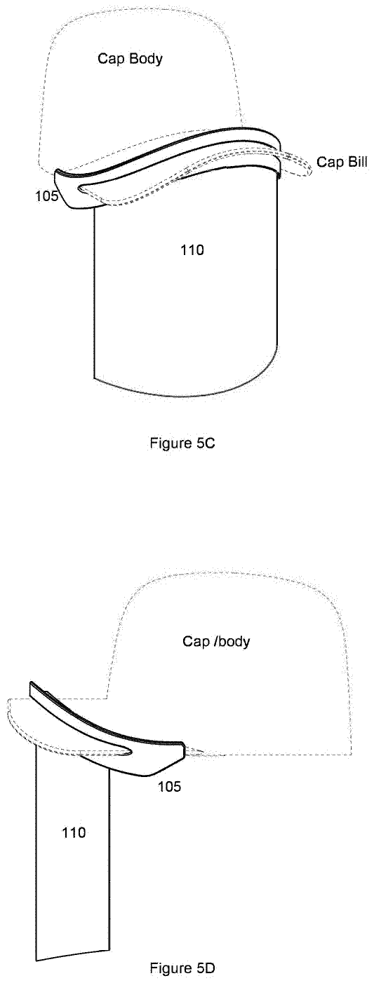

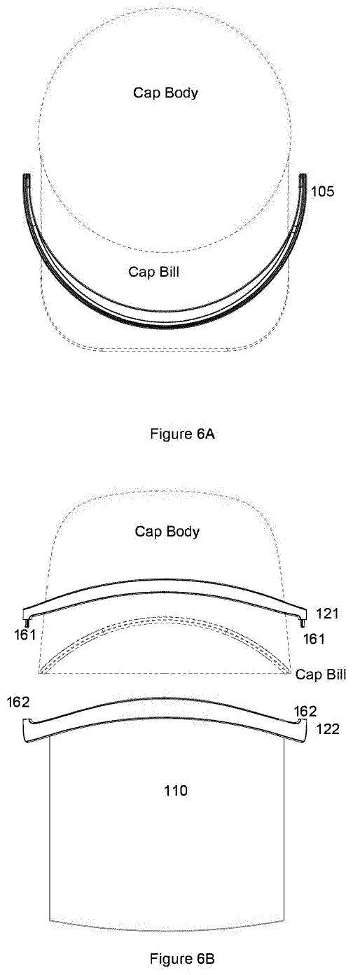

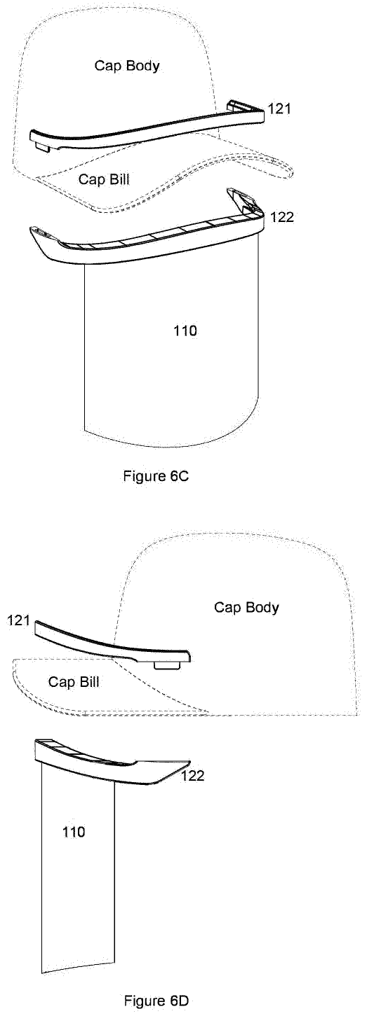

FIGS. 5A-5D illustrate a fifth configuration of the cap face shield where the connection plate 105 is two pieces (a top piece 121 and a bottom piece 122 as shown in FIGS. 6A-6D). In some embodiments, the bottom piece 122 of the connection plate 105 connects to the face shield 110 on its bottom side (utilizing the channel described in FIGS. 7-9). In some embodiments, the bottom piece 122 may connect or fasten to the top piece 121. In some embodiments, this may occur via snap fit connections. For example, as illustrated in FIGS. 6A-6D, there may be ledges or tabs 161 on the top piece 121 that fit into holes or recesses 162 of the bottom piece 122. This allows for easier adjustment to different cap sizes and/or different cap bill sizes. FIG. 10 is a rendering of a cap shield according to some embodiments.

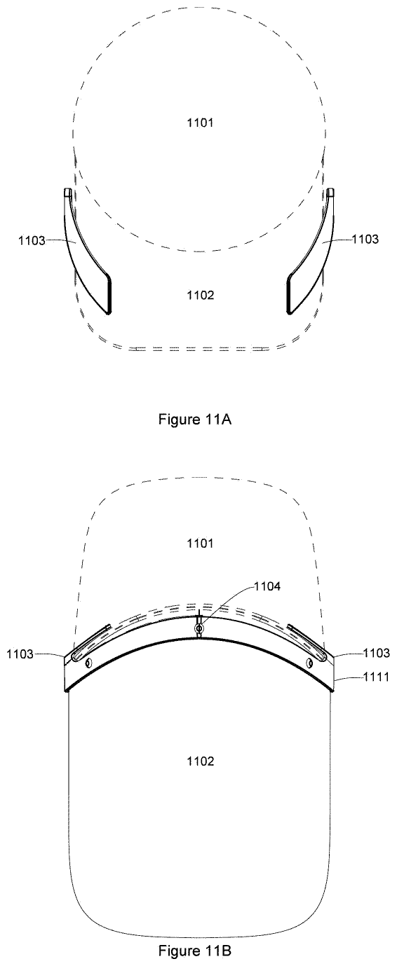

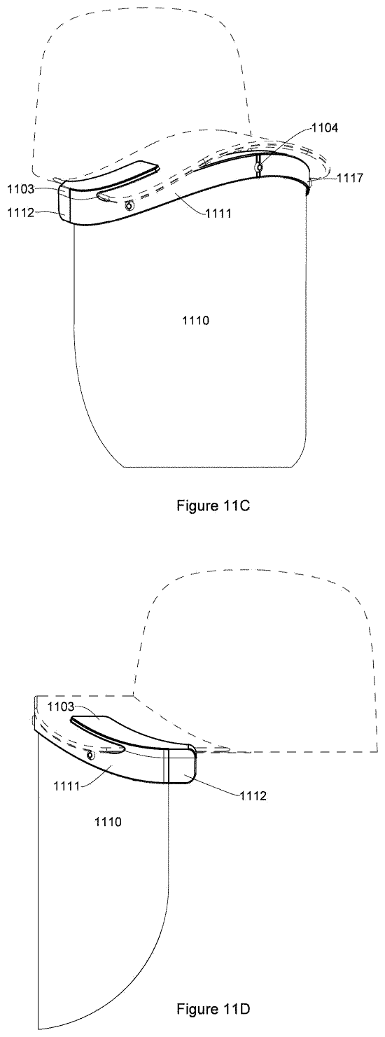

FIG. 11A is a top view of a cap shield according to some embodiments. FIG. 11B is a front view of a cap shield according to some embodiments. FIG. 11C is a right perspective view of a cap shield according to some embodiments. FIG. 11D is a left side view of a cap shield according to some embodiments. In some embodiments, the face shield protects the user or wearer from bacterial or other germs and allows individuals like first responders more protection. The design is simple and is easily attached to a cap. In some embodiments, sides or side hinges 1103 are attached to a bill of a cap 1102. In some embodiments, the sides or side hinges are attached to an end 1112 of the shield attachment assembly 1111. In some embodiments, the shield 1110 is attached to the shield attachment assembly 1111 at a bottom side of the shield attachment assembly 1111 and slides through the channel. In order for the shield 1110 to remain in the shield attachment assembly 1111, one or more fasteners or screws 1104 and 1117 are utilized to connect or couple the shield 1110 to the shield attachment assembly 1111. In some embodiments, one or more fasteners or screws 1104 may be central fasteners. In some embodiments, one or more fasteners or screws 1117 may be side fasteners. In some embodiments, the shield 1110 and/or the shield attachment assembly 1111 may be curved in shape or alternatively in a semi-circular shape to be substantially similar with a shape of the bill 1101 of the cap.

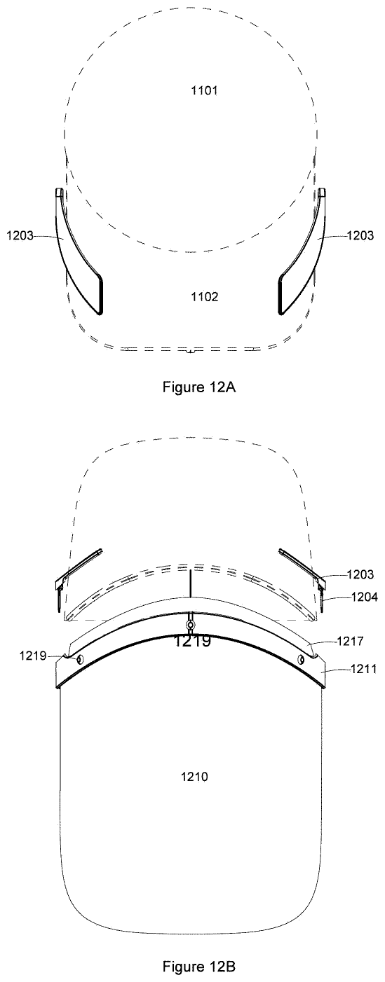

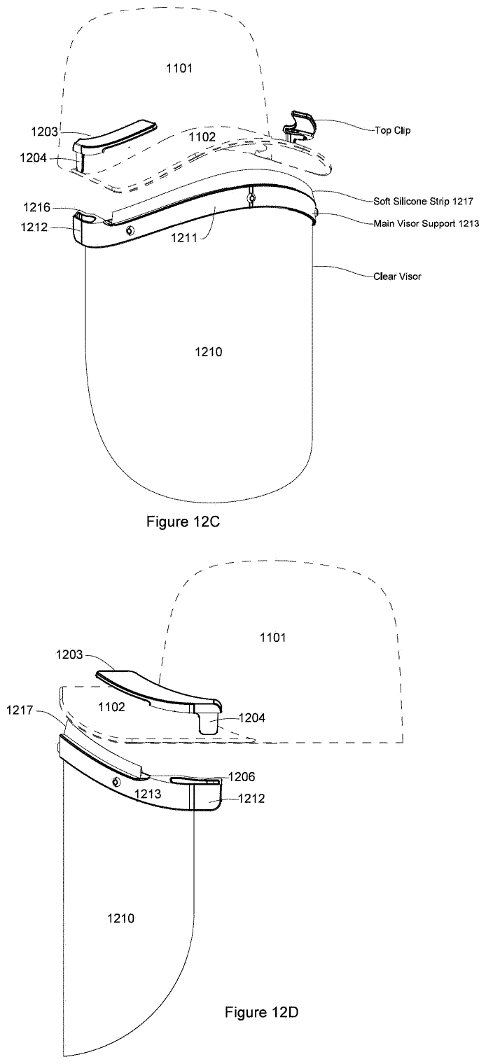

FIG. 12A illustrates a top view of a cap shield according to some embodiments. FIG. 12B illustrates a front view of a cap shield according to some embodiments. FIG. 12C illustrates a right perspective view of a cap shield according to some embodiments. FIG. 12D illustrates a left perspective view of a cap shield according to some embodiments. In some embodiments, the side attachment or side hinging assembly may include a top flat portion 1203 that is positioned on a top surface of the side of a bill of a cap. In some embodiments, the side attachment or side hinging assembly may include a clip or attachment assembly 1204 that may be perpendicular to the top flat portion 1203 and may also be inserted into a hole or recess 1216 in a shield attachment assembly 1211. In some embodiments, the side attachment or side hinging assembly allows the cap shield to be attached to the bill of the cap 1102. In some embodiments, the cap shield further includes a shield attachment assembly 1211 includes two side portions 1212 that may be curved in shape and attach to a center section of the shield attachment assembly 1211. In some embodiments, the cap shield further includes a soft silicone strip 1217 and a main visor or cap support 1211. In some embodiments the soft silicon strip 1217 allows for a top surface of the shield attachment assembly 1211 to have a softer surface that is touching a bottom surface of the bill 1102 of the cap 1101. This minimizes wear and tear on the cap. In some embodiments, the soft silicone strip 1217 is attached to a top portion of the main visor or cap support 1213. In some embodiments, one or more clips or attachment assemblies 1204 may connect, attach and/or couple the top or flat portion 1203 to one or more recesses or openings 1216 in the shield attachment assembly 1211 in order to attach or connect the cap shield to the cap. In some embodiments, the visor or shield 1210 may be adhered, connected or attached to a bottom surface of the main visor support 1213. In some embodiments, the visor or shield 1210 may be inserted into a channel on a bottom surface of the main visor or shield support. In some embodiments, the visor or shield 1210 may be eight inches in height, or alternatively may range from 5 inches to 12 inches in height depending on the application. In some embodiments, the shield may be clear or transparent, or in some embodiments, the visor or shield may be tinted and/or include UV protection. In some embodiments, the shield 1210 may be fastened to the shield attachment assembly 1211 via one or more fasteners 1219.

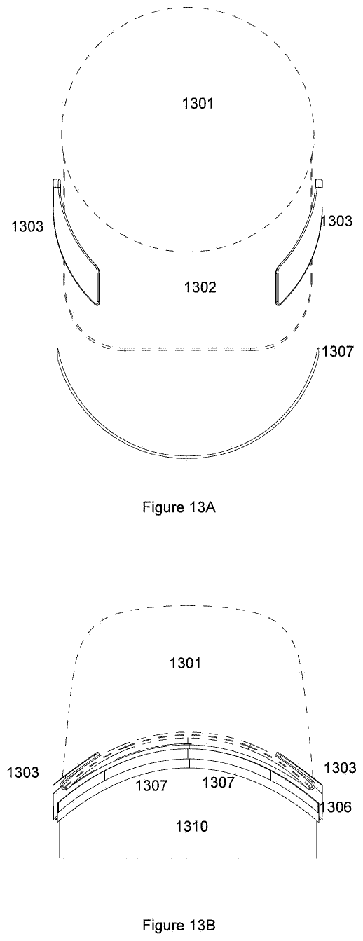

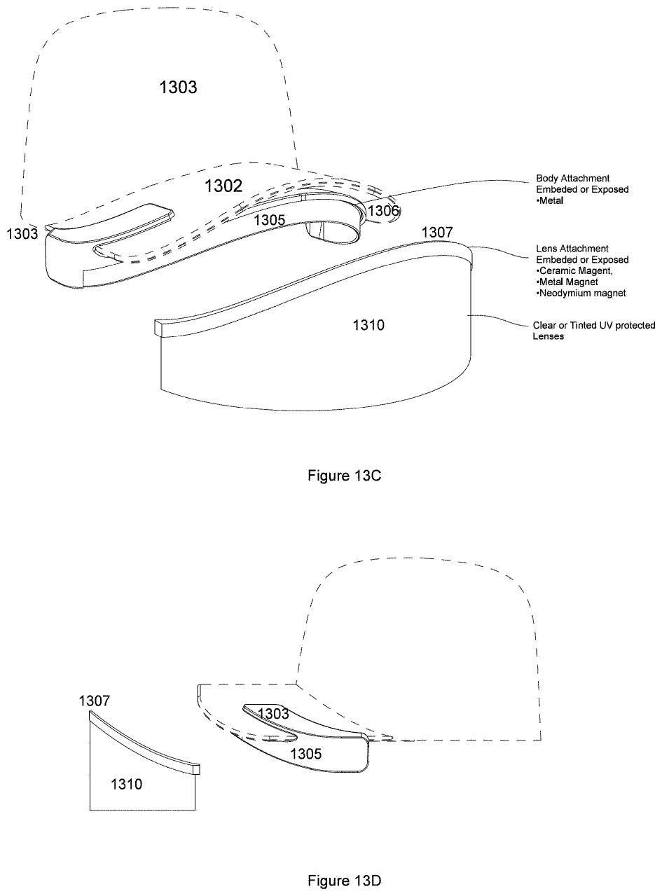

FIG. 13A illustrates a top view of a cap lens or cap shade apparatus or device according to some embodiments. In some embodiments, a cap lens or cap shade apparatus may include a body 1305 and sides or side hinges 1303. In some embodiments, the side hinges 1303 may attach over a side of the bill 1302 of the cap. In some embodiments, this means that the cap lens or cap shade apparatus may not touch the main body 1301 of the cap. In some embodiments, the cap lens or cap shade provides UV protection or other glass protection to the eyes. In some embodiments, the body 1305 of the cap lens or cap shade may be semi-circular in shape and may be similar to the shape of a front part of a bill 1302 of the cap. In some embodiments, the body 1305 of the cap lens or cap shade may have a curved shape. In some embodiments, the body 1305 of the cap lens or cap shade apparatus may include a ridge 1306 that goes from one side to the other across the top part of the body 1305. In some embodiments, the body or body attachment 1305 and/or the ridge 1306 may be made of a metallic material. In some embodiments, the body or body attachment 1305 and/or the ridge 1306 may be made of a magnetic material. In some embodiments, a lens assembly may comprise a lens 1310 and a lens attachment 1307. In some embodiments, the lens 1310 and/or the lens attachment may be curved in shape. In some embodiments, the lens 1310 and/or the lens attachment 1307 may be semi-circular in shape. In some embodiments, the lens 1310 may be inserted into a channel on a bottom side of the lens attachment 1307. In some embodiments, the lens 1310 may be attached to the bottom side of the lens attachment 1307. In some embodiments, the lens attachment 1307 may made of a metallic or ceramic material. In some embodiments, the lens attachment 1307 may be made of a magnetic material (either ceramic or metallic). In some embodiments, lens attachment 1307 may be connected, adhered or magnetically coupled to the body attachment 1305. In some embodiments, the lens attachment 1307 may fit under the ledge or ridge 1306 of the body assembly. In some embodiments, the center of the lens 1310 may have a larger height than the height on the curved side of the lens 1310. In some embodiments, the height of the lens 1310 may be 2.5 inches. In some embodiments, the height of the lens 1310 may be between 1.5 inches to 4 inches.

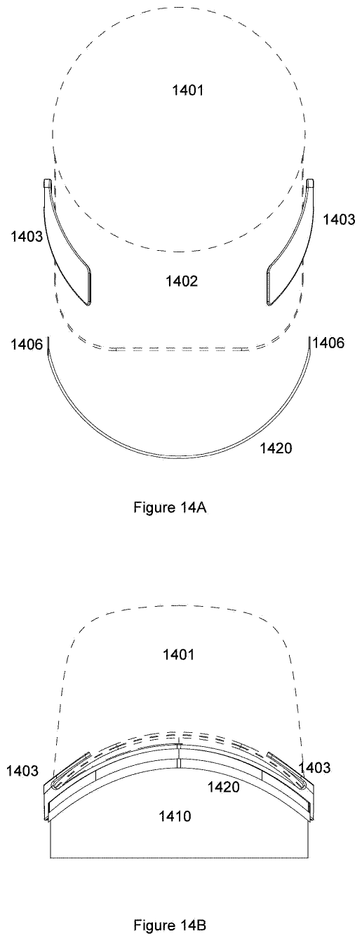

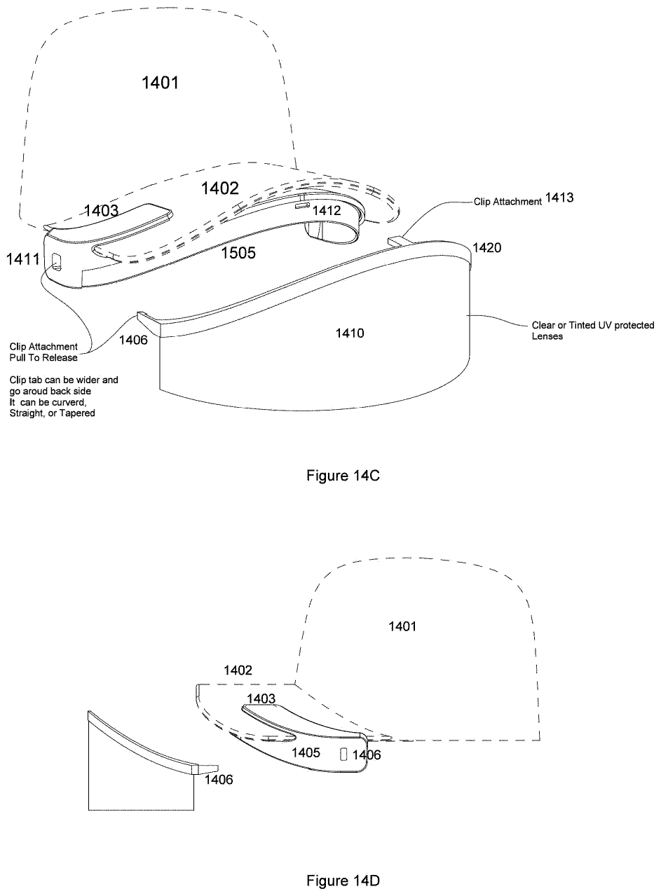

FIG. 14A illustrates a top view of a second configuration of a cap lens or cap shade according to some embodiments. FIG. 14B illustrates a front view of a cap lens or cap shade according to some embodiments. FIG. 14C illustrates a right side perspective view of a cap lens or cap shade according to some embodiments. FIG. 14D illustrates a left side perspective view of a cap lens or cap shade according to some embodiments.

In some embodiments, the cap lens or cap shade may include sides or hinging assemblies 1403, a body or body attachment 1405 and a lens assembly (which includes a lens attachment 1420 and a lens 1410). In some embodiments, the sides or hinging assemblies 1403 attach the cap lens or cap shade to sides of the bill 1402 of the cap. In some embodiments, the sides or hinging assemblies 1403 may not touch the main body 1401 of cap. In some embodiments, the lens assembly (and specifically the lens attachment 1420) may connect to the body or body attachment 1405 utilizing a different device or system than what is described in FIGS. 13A-13D. In some embodiments, body or body attachment 1405 may include a plurality of recesses or holes. In some embodiments, the recesses or holes may include side recesses or holes 1411 and/or a front recess(es) or hole(s) 1412. In some embodiments, the lens attachment 1420 may include a plurality of clips or ledges. In some embodiments, the plurality of clips or ledges include one or more side attachment clips or ledges 1406 and one or more front or center attachment clips or ledges 1413. In some embodiments, the lens attachment 1420 (and thus lens 1410) may be connected or attached to the body or body attachment 1405 by inserting the side attachment clips or ledges 1405 into the side recesses or holes 1411 and/or by inserting the front attachment clips or ledges 1413 into the front recess(es) or hole(s) 1412. In some embodiments, the lens attachment 1420 may fit under the ridge 1407 on the body or body attachment 1405. In some embodiments, the lens 1410 may be made of a clear, transparent or tinted or UV protected material. In some embodiments, the lens attachment 1420 may be made of an embedded or exposed ceramic magnetic material, a metal magnetic material, and/or a neodymium magnetic material. In some embodiments, the body attachment 1405 may be made of an embedded or exposed metal material. In other embodiments, the body attachment 1405 may be made of an embedded or exposed ceramic magnetic material, a metal magnetic material, and/or a neodymium magnetic material. In other embodiments, the lens attachment 1420 may be made of an embedded or exposed metal material.

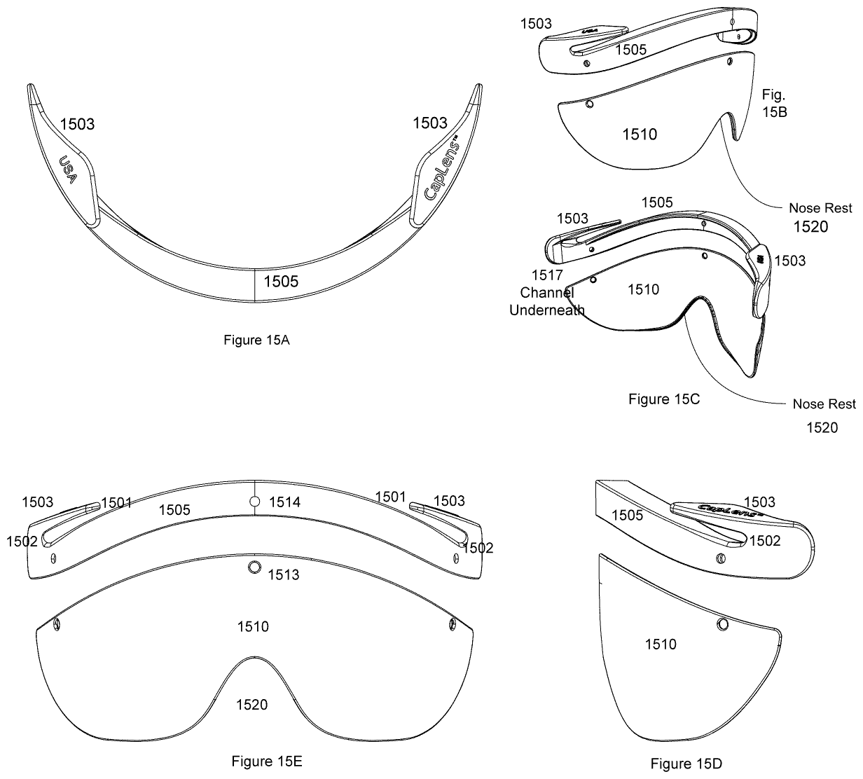

FIG. 15A illustrates a top view of a cap shield according to some embodiments. FIG. 15B illustrates a left perspective view of a cap shield according to some embodiments. FIG. 15C illustrates a back right perspective view of a cap shield according to some embodiments. FIG. 15D illustrates a front right perspective view of a cap shield according to some embodiments. FIG. 15E illustrates a back view of a cap shield according to some embodiments. The cap shield 1500 includes a lens 1510 and a body attachment 1505. In FIGS. 15A-15E, the lens 1510 may be connected to the body attachment 1505 via fasteners inserted through openings 1513 and/or 1514. In some embodiments, the body attachment 1505 may have a channel 1517 where the lens 1510 may be inserted. In addition, the body attachment 1505 may attach or connect to the lens via the mechanisms and assemblies described above with respect to FIGS. 12A-D; FIGS. 13A-D and FIGS. 14A-d (including but not limited to magnetic connection. In some embodiments, the cap shield 1500 and specifically the body attachment 1505 may be connected to a bill of the cap utilizing the clips or ledges or attachment assemblies 1503. In these embodiments, the clips or leges or attachment assemblies 1503 may include openings 1501 where the bill of the cap may be positioned or inserted. In these embodiments, an edge of the cap bill (on each side) may be rest against an edge 1502 of the clips or ledges or attachment assemblies 1503 so that the cap shield does not move. The configuration of the cap shield 1500 in FIGS. 15A-15E allows a user to move the cap shield 1500 left or right on the bill of the cap to achieve the best fitting position and this makes it very beneficial for users. The cap shield illustrated in FIGS. 15A-15E also includes a nose bridge for users. FIGS. 15B, 15C and 15E illustrate an opening or nose bridge 1530 so that the lens may sit comfortably on the user's nose without having to place to far away from the user's face. In some embodiments, the lens 1510 may be made of a plastic material. In some embodiment, the lens 1510 may be made of a material that includes UV shading.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

As used herein, the term “or” is used inclusively to refer items in the alternative and in combination.

As used herein, characters such as numerals refer to like elements.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

1. A cap shield comprising:
two or more side attachment assemblies; the two or more side attachment assemblies including corresponding two or more top portions and two or more clip assemblies, the two or more clip assemblies directed downward in a vertical direction which is perpendicular to the top portion, the two or more side attached assemblies to attach to a bill of a cap;
a shield attachment assembly, the shield attachment assembly include two or more side portions having associated two or more recesses to receive the two or more clip assemblies to connect the two or more side attachment assemblies to the shield attachment assembly; and
a shield or lens, the shield or lens to be attached to the shield attachment assembly.

2. A cap shield, comprising:
a body including two or more side hinges and a ridge, the two or more side hingers to attach onto respective opposite sides of a cap and the ridge running from one side to the other side across a front of the body, wherein the ridge includes a metal material; and
a lens, the lens made of a plastic material, and a lens attachment assembly, the lens attachment assembly connected to the lens on a front surface of the lens and running from left to right across the lens,
wherein the lens attachment assembly is made of a magnetic material and wherein the lens attachment assembly connects to the lens to the metallic ridge of the body.

3. A cap shield, comprising:
two or more side hinging assemblies, the two more side hinging assemblies including associated holes or openings and the two or more side hinging assemblies attached to a bill of a cap via an opening in the side hinging assemblies;
a body, the two or more side hinging assemblies connect to opposing left and right ends of the body;
a lens assembly, the lens assembly including a lens, a lens attachment, and two or more side attachment clips or protrusions,
wherein the lens is connected to the lens attachment and the lens attachment is connected to the two or more side attachment clips or protrusions, and
wherein the two or more side attachment clips or protrusions are inserted into the associated holes or openings of the two or more side hinging assemblies to connect the lens attachment to the body and the two or more side hinges.
